(19) United States
(12) Patent Application Publication
(10) Pub. No.: US 2024/0132072 A1
(43) Pub. Date: Apr. 25, 2024

(54) VEHICLE MOVING APPARATUS

(71) Applicant: TOYOTA JIDOSHA KABUSHIKI KAISHA, Toyota-shi (JP)

(72) Inventor: Hideki KAMATANI, Nagoya-shi (JP)

(73) Assignee: TOYOTA JIDOSHA KABUSHIKI KAISHA, Toyota-shi (JP)

(21) Appl. No.: 18/359,358

(22) Filed: Jul. 25, 2023

(30) Foreign Application Priority Data
Oct. 23, 2022 (JP) 2022-169772

(51) Int. Cl. B60W 30/18

(52) U.S. Cl. CPC B60W 30/18072; B60W 2510/0647

(57) ABSTRACT

A vehicle moving apparatus executes an autonomous acceleration/deceleration control including a coasting control and an acceleration control. The apparatus continues executing the coasting control until a predetermined time elapses even when a distance between an own vehicle and a preceding vehicle increases and reaches an upper limit value of a predetermined distance range when a moving speed of the own vehicle becomes equal to or greater than a predetermined speed, the moving speed of the own vehicle is greater than a moving speed of the preceding vehicle, and a difference between the moving speed of the own vehicle and the moving speed of the preceding vehicle is equal to or greater than a predetermined speed difference while the coasting control is executed.

### CROSS-REFERENCE TO RELATED APPLICATIONS

This application claims priority to Japanese patent application No. JP 2022-169772 filed on Oct. 24, 2022, the content of which is hereby incorporated by reference in its entirety.

### BACKGROUND

### Field

The present invention relates to a vehicle moving apparatus.

### Description of the Related Art

There is known a vehicle moving apparatus which executes a following moving control to cause an own vehicle to move so as to follow a preceding vehicle. Further, as such a vehicle moving apparatus, there is known a vehicle moving apparatus which causes the own vehicle to coast so as to reduce an amount of energy consumed for moving the own vehicle when the following moving control is executed, and the own vehicle is requested to be decelerated (for example, refer to JP 4677945 B).

In the known vehicle moving apparatus, when the following moving control is executed, the amount of the energy consumed for moving the own vehicle is reduced as a time of causing the own vehicle to coast increases. On the other hand, when the own vehicle coasts for a long time, an operator of the own vehicle may feel discomfort, depending on situations.

### SUMMARY

An object of the present invention is to provide a vehicle moving apparatus which can reduce the amount of the energy consumed for moving the own vehicle without giving a sense of discomfort to the operator of the own vehicle.

According to the present invention, a vehicle moving apparatus comprises an electronic control unit configured to execute an autonomous acceleration/deceleration control to autonomously control an acceleration and a deceleration of an own vehicle so as to control a distance between the own vehicle and a preceding vehicle within a predetermined distance range by (i) starting to execute a coasting control to cause the own vehicle to coast when the distance between the own vehicle and the preceding vehicle decreases and reaches a lower limit value of the predetermined distance range and (ii) starting to execute an acceleration control to accelerate the own vehicle when the distance between the own vehicle and the preceding vehicle increases and reaches an upper limit value of the predetermined distance range.

The electronic control unit is configured to continue executing the coasting control until a predetermined time elapses even when the distance between the own vehicle and the preceding vehicle increases and reaches the upper limit value of the predetermined distance range when (i) a moving speed of the own vehicle becomes equal to or greater than a predetermined speed, (ii) the moving speed of the own vehicle is greater than a moving speed of the preceding vehicle, and (iii) a difference between the moving speed of the own vehicle and the moving speed of the preceding vehicle is equal to or greater than a predetermined speed difference while the coasting control is executed.

If (i) the coasting control starts to be executed when the distance between own vehicle and the preceding vehicle reaches the lower limit value of the predetermined distance range, and (ii) the acceleration control starts to be executed when the distance between own vehicle and the preceding vehicle reaches the upper limit value of the predetermined distance range while the autonomous acceleration/deceleration control is executed, and the preceding vehicle is frequently accelerated and decelerated, executions of the coasting control and the acceleration control are frequently switched. Thereby, the energy consumed by the own vehicle may be increased, and the own vehicle may repeatedly approach or leave the preceding vehicle. Thereby, it may give a sense of discomfort to the operator of the own vehicle.

On the other hand, when the preceding vehicle is frequently accelerated and decelerated, the executions of the coasting control and the acceleration control are not frequently switched by increasing the time of continuously executing the coasting control and thereby, increasing the time of continuously executing the acceleration control. Thereby, the amount of the energy consumed for moving the own vehicle can be reduced without giving a sense of discomfort to the operator of the own vehicle.

With the present invention, when (i) the moving speed of the own vehicle becomes equal to or smaller than the predetermined speed, (ii) the moving speed of the preceding vehicle is greater than the moving speed of the own vehicle, and (iii) the difference between the moving speed of the own vehicle and the moving speed of the preceding vehicle is equal to or greater than the predetermined speed difference, the coasting control continues to be executed until the predetermined time elapses even when the distance between the own vehicle and the preceding vehicle increases and reaches the upper limit value of the predetermined distance range. Therefore, the amount of the energy consumed for moving the own vehicle can be reduced without giving a sense of discomfort to the operator of the own vehicle.

According to an aspect of the present invention, the acceleration control may be a control to activate an internal combustion engine of the own vehicle and accelerate the own vehicle by a power output from the internal combustion engine. In this aspect, the coasting control may be a control to stop activating the internal combustion engine and causing the own vehicle to coast. Further, in this aspect, the predetermined time may be set to a greater value as the moving speed of the own vehicle is greater when the distance between the own vehicle and the preceding vehicle increases and reaches the upper limit value of the predetermined distance range while the coasting control is executed.

The amount of the energy consumed for starting to activate the internal combustion engine when the own vehicle moves at a low speed, is greater than the amount of the energy consumed for starting to activate the internal combustion engine when the own vehicle moves at a high speed. Therefore, if the number of times of starting to activate the internal combustion engine is reduced when the moving speed of the own vehicle is low, the amount of the energy consumed for starting to activate the internal combustion engine can be reduced and as a result, the amount of the energy consumed for moving the own vehicle can be reduced.

With this aspect of the present invention, when the distance between the own vehicle and the preceding vehicle increases and reaches the upper limit value of the predetermined distance range while the coasting control is executed, the predetermined time is set to a greater value and as a result, the time for continuing to execute the coasting control becomes greater as the moving speed of the own vehicle decreases. Therefore, the number of times of starting to activate the internal combustion engine can be reduced and as a result, the amount of energy consumed for moving the own vehicle can be reduced.

Elements of the invention are not limited to elements of embodiments and modified examples of the invention described with reference to the drawings. The other objects, features and accompanied advantages of the invention can be easily understood from the embodiments and the modified examples of the invention.

### BRIEF DESCRIPTION OF THE DRAWINGS

FIG. 1 is a view which shows a vehicle moving apparatus according to an embodiment of the present invention.

FIG. 2A is a view which shows a scene that there is a preceding vehicle ahead of an own vehicle.

FIG. 2B is a view which shows a scene that there is no preceding vehicle ahead of the own vehicle.

FIG. 3 is a view which shows a flowchart of a routine executed by the vehicle moving apparatus according to the embodiment of the present invention.

FIG. 4 is a view which shows a flowchart of a routine executed by the vehicle driving apparatus according to the embodiment of the present invention.

FIG. 5 is a view which shows a flowchart of a routine executed by the vehicle driving apparatus according to the embodiment of the present invention.

FIG. 6A is a view which shows a scene that there is the preceding vehicle ahead of the own vehicle, and there is a following vehicle behind the own vehicle.

FIG. 6B is a view which shows a scene that there is no preceding vehicle ahead of the own vehicle, and there is the following vehicle behind the own vehicle.

### DESCRIPTION OF THE EMBODIMENTS

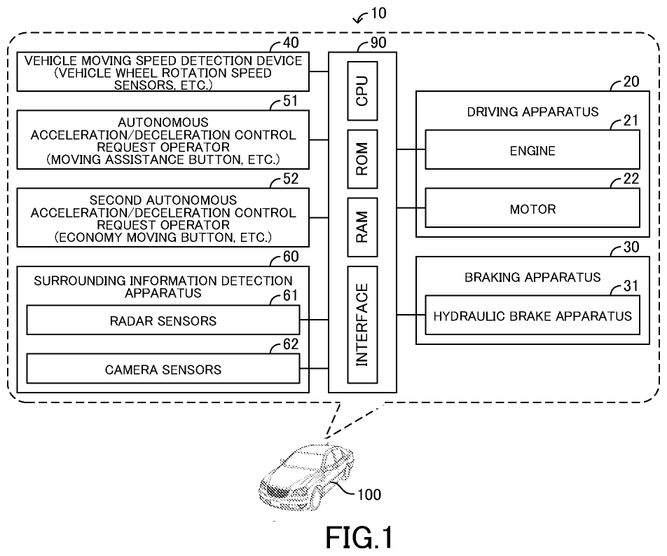

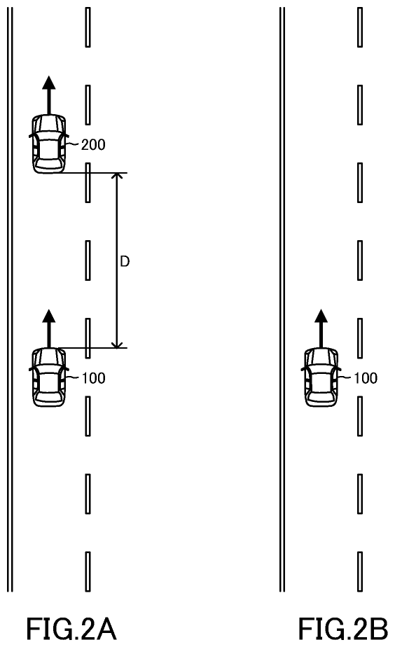

Below, a vehicle moving apparatus according to an embodiment of the present invention will be described with reference to the drawings. As shown in FIG. 1, the vehicle moving apparatus 10 according to the embodiment of the present invention is mounted on an own vehicle 100. Hereinafter, the vehicle moving apparatus 10 will be described by exemplifying that an operator of the own vehicle 100 is a driver of the own vehicle 100, i.e., a person who rides on the own vehicle 100 and drives the own vehicle 100.

However, the operator of the own vehicle 100 may be a remote operator of the own vehicle 100, i.e., an operator who is not in the own vehicle 100 but remotely drives the own vehicle 100. When the operator of the own vehicle 100 is the remote operator, the vehicle moving apparatus 10 is mounted on the own vehicle 100 and a remote control facility installed outside the own vehicle 100 for remotely driving the own vehicle 100, and functions of the vehicle moving apparatus 10 described below are realized by the vehicle moving apparatus 10 mounted on the own vehicle 100 and the vehicle moving apparatus 10 mounted on the remote control facility.

The vehicle moving apparatus 10 includes an ECU (an electronic control device) 90. The ECU 90 includes a microcomputer as a main component. The microcomputer includes a CPU, a ROM, a RAM, a non-volatile memory, and an interface. The CPU implements various functions by executing instructions, programs, or routines stored in the ROM. In the present embodiment, the vehicle moving apparatus 10 includes one ECU, but a plurality of ECUs may be provided, and various processes described later may be executed by the ECUs.

The vehicle moving apparatus 10 executes an autonomous acceleration/deceleration control as an autonomous driving control or an automatic driving control. The autonomous acceleration/deceleration control is a control to cause the own vehicle 100 to move by autonomously controlling a driving apparatus 20 and a braking apparatus 30 to accelerate or decelerate the own vehicle 100. In the present embodiment, the autonomous acceleration/deceleration control includes an inter-vehicle distance control and a moving speed control. Further, in the present embodiment, the driving apparatus 20 includes an internal combustion engine 21 and an electric motor 22, and the braking apparatus 30 includes a hydraulic brake apparatus 31.

The inter-vehicle distance control is a control executed when there is a preceding vehicle 200 ahead of the own vehicle 100 as shown in 2A and is one of the autonomous acceleration/deceleration controls to autonomously accelerate or decelerate the own vehicle 100, based on a target inter-vehicle distance Dtgt.

The preceding vehicle 200 is another vehicle moving ahead of the own vehicle 100 within a predetermined distance (or a preceding vehicle determination distance Dth) from the own vehicle 100. The vehicle moving apparatus 10 detects the preceding vehicle 200, based on surrounding detection information IS described later.

The target inter-vehicle distance Dtgt is an inter-vehicle distance D set by the driver as a control target used by the inter-vehicle distance control. The inter-vehicle distance D is a distance between the own vehicle 100 and the preceding vehicle 200. The vehicle moving apparatus 10 acquires the inter-vehicle distance D, based on the surrounding detection information IS described later.

On the other hand, the moving speed control is a control executed when there is no preceding vehicle 200 ahead of the own vehicle 100 as shown in 2B and is one of the autonomous acceleration/deceleration controls to autonomously accelerate or decelerate the own vehicle 100, based on a set speed Vset. The set speed Vset is a moving speed of the own vehicle 100 (or an own vehicle moving speed Vego) set by the driver as a control target used by the moving speed control. The vehicle moving apparatus 10 acquires the own vehicle moving speed Vego by a vehicle moving speed detection device 40.

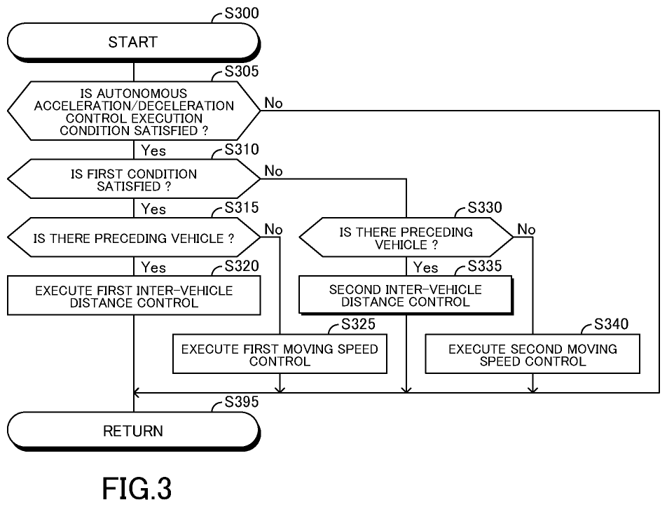

Next, operations of the vehicle moving apparatus 10 will be described in more detail. The vehicle moving apparatus 10 executes a routine shown in FIG. 3 with a predetermined calculation cycle. When the vehicle moving apparatus 10 starts a process from a step S300 of the routine shown in FIG. 3, the vehicle moving apparatus 10 proceeds with the process to a step S305 to determine whether an autonomous acceleration/deceleration control execution condition C0 is satisfied. The autonomous acceleration/deceleration control execution condition C0 is a condition that the autonomous acceleration/deceleration control is requested to be executed. The driver can request the vehicle moving apparatus 10 to execute the autonomous acceleration/deceleration control by operating an autonomous acceleration/deceleration control request operator 51 such as a moving assistance button.

When the vehicle moving apparatus 10 determines “Yes” at the step S305, the vehicle moving apparatus 10 proceeds with the process to a step S310 to determine whether a first condition C1 is satisfied. The first condition C1 is a condition that a second autonomous acceleration/deceleration control (or an economy moving control) is not requested to be executed. The driver can request the vehicle moving apparatus 10 to execute the second autonomous acceleration/deceleration control by operating a second autonomous acceleration/deceleration control request operator 52 such as an economy moving button. Further, in the present embodiment, the second autonomous acceleration/deceleration control includes a second inter-vehicle distance control and a second moving speed control described later.

When the vehicle moving apparatus 10 determines “Yes” at the step S310, the vehicle moving apparatus 10 proceeds with the process to a step S315 to determine whether there is the preceding vehicle 200. The vehicle moving apparatus 10 determines whether there is the preceding vehicle 200, based on the surrounding detection information IS.

The surrounding detection information IS is information provided from a surrounding information detection apparatus 60. In the present embodiment, the surrounding information detection apparatus 60 includes radar sensors 61 and camera sensors 62. The surrounding information detection apparatus 60 provides the vehicle moving apparatus 10 with radar detection information, i.e., information on situations around the own vehicle 100 acquired by the radar sensors 61 as the surrounding detection information IS. In addition, the surrounding information detection apparatus 60 provides the vehicle moving apparatus 10 with image information, i.e., image data on views around the own vehicle 100 acquired by the camera sensors 62 as the surrounding detection information IS.

When the vehicle moving apparatus 10 determines “Yes” at the step S320, the vehicle moving apparatus 10 proceeds with the processing to a step S320 to execute a first inter-vehicle distance control. Then, the vehicle moving apparatus 10 proceeds with the processing to a step S395 to terminate executing this routine once.

The first inter-vehicle distance control is a control to maintain the inter-vehicle distance D at the target inter-vehicle distance Dtgt. In the present embodiment, the first inter-vehicle distance control is one of first autonomous acceleration/deceleration controls. In particular, the first inter-vehicle distance control is a control to autonomously control activations of the driving apparatus 20 and the braking apparatus 30 to accelerate or decelerate the own vehicle 100 such that the inter-vehicle distance D is maintained at the target inter-vehicle distance Dtgt. Therefore, the first inter-vehicle distance control is a so-called following moving control or an adaptive cruise control.

On the other hand, when the vehicle moving apparatus 10 determines “No” at the step S315, the vehicle moving apparatus 10 proceeds with the process to a step S325 to execute a first moving speed control. Then, the vehicle moving apparatus 10 proceeds with the process to the step S395 to terminate executing this routine once.

The first moving speed control is a control to maintain the own vehicle moving speed Vego at the set speed Vset. In the present embodiment, the first moving speed control is one of the first autonomous acceleration/deceleration controls. In particular, the first moving speed control is the autonomous acceleration/deceleration control to autonomously control the activations of the driving apparatus 20 and the braking apparatus 30 to accelerate or decelerate the own vehicle 100 such that the own vehicle moving speed Vego is maintained at the set speed Vset. Therefore, the first moving speed control is a so-called constant speed moving control or a cruise control.

When the vehicle moving apparatus 10 determines “No” at the step S310, the vehicle moving apparatus 10 proceeds with the process to a step S330 to determine whether there is the preceding vehicle 200. That is, when the first condition C1 is not satisfied at the step S310, and therefore a second condition C2 that the second autonomous acceleration/deceleration control (or the economy moving control) is requested to be executed, is satisfied, the vehicle moving apparatus 10 proceeds with the process to the step S330 to determine whether there is the preceding vehicle 200.

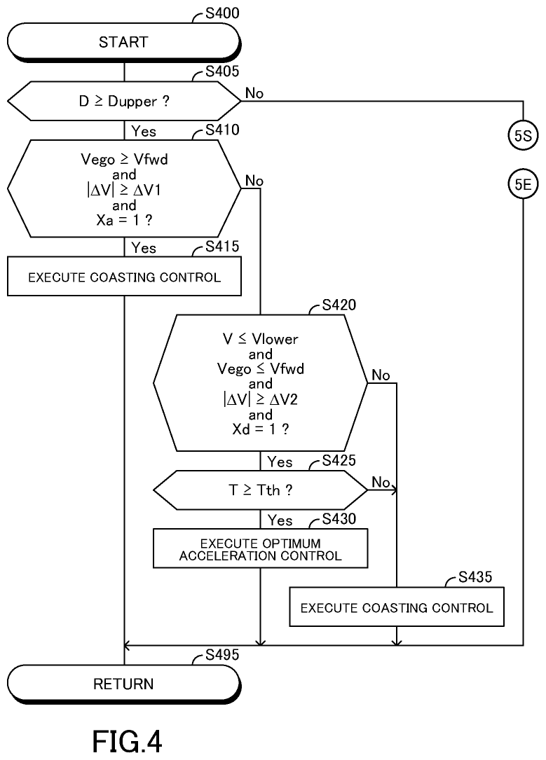

When the vehicle moving apparatus 10 determines “Yes” at the step S330, the vehicle moving apparatus 10 proceeds with the process to a step S335 to execute the second inter-vehicle distance control by executing a routine shown in FIG. 4 as will be described later. Then, the vehicle moving apparatus 10 proceeds with the process to the step S395 to terminate executing this routine once.

In general, the second inter-vehicle distance control is one of the autonomous acceleration/deceleration controls to autonomously control an acceleration and a deceleration of the own vehicle 100 such that the distance between the own vehicle 100 and the preceding vehicle 200 (i.e., the inter-vehicle distance D) is within a predetermined distance range Rd by (i) starting to execute a coasting control to cause the own vehicle 100 to coast when the distance between the own vehicle 100 and the preceding vehicle 200 (i.e., the inter-vehicle distance D) increases and reaches an upper limit distance Dupper, i.e., an upper limit value of the predetermined distance range Rd, and (ii) starting to execute an acceleration control to accelerate the own vehicle 100 when the distance between the own vehicle 100 and the preceding vehicle 200 (i.e., the inter-vehicle distance D) decreases and reaches a lower limit distance Dlower, i.e., a lower limit value of the predetermined distance range Rd.

In other words, the second inter-vehicle distance control is generally a control to maintain the inter-vehicle distance D at a distance within the predetermined distance range Rd including the target inter-vehicle distance Dtgt by (i) executing an optimum acceleration control when the inter-vehicle distance D increases and reaches the upper limit distance Dupper, i.e., the upper limit value of the predetermined distance range Rd and (ii) executing the coasting control when the lower limit distance Dlower, i.e., the inter-vehicle distance D decreases and reaches the lower limit value of the predetermined distance range Rd.

On the other hand, when the vehicle moving apparatus 10 determines “No” at the step S330, the vehicle moving apparatus 10 proceeds with the process to a step S340 to execute the second moving speed control. Then, the vehicle moving apparatus 10 proceeds with the process to the step S395 to terminate executing this routine once.

The second moving speed control is a control to maintain the own vehicle moving speed Vego at a speed within a predetermined speed range Rv including the set speed Vset by (i) controlling the activation of the driving apparatus 20 to accelerate the own vehicle 100 when the own vehicle moving speed Vego decreases and reaches a lower limit speed Vlower, i.e., a lower limit value of the predetermined speed range Rv and (ii) controlling the activation of the driving apparatus 20 to decelerate the own vehicle 100 when the own vehicle moving speed Vego increases and reaches an upper limit speed Vupper, i.e., an upper limit value of the predetermined speed range Rv.

In particular, the second moving speed control is a control to (i) accelerate the own vehicle 100 by executing the optimum acceleration control when the own vehicle moving speed Vego decreases and reaches the lower limit speed Vlower and (ii) decele rate the own vehicle 100 by executing the coasting control when the own vehicle moving speed Vego increases and reaches the upper limit speed Vupper.

The optimum acceleration control is a control to control the activation of the driving apparatus 20 such that power is output from the driving apparatus 20 with the highest energy efficiency, and in particular, a control to operate the internal combustion engine 21 at an optimum operating point (or an operating point near the optimum operating point).

On the other hand, the coasting control is a control to control the activation of the driving apparatus 20 such that the own vehicle 100 coasts.

Further, when the vehicle moving apparatus 10 determines “No” at the step S305, the vehicle moving apparatus 10 proceeds with the process directly to the step S395 to terminate executing this routine once.

Next, the routine shown in FIG. 4 will be described. When the vehicle moving apparatus 10 proceeds with the process to the step S335 of the routine shown in FIG. 3, the vehicle moving apparatus 10 starts a process from a step S400 of the routine shown in FIG. 4 and proceeds with the process to a step S405 to determine whether the inter-vehicle distance D is equal to or greater than the upper limit distance Dupper.

When the vehicle moving apparatus 10 determines “Yes” at the step S405, the vehicle moving apparatus 10 proceeds with the process to a step S410 to determine whether (i) the own vehicle moving speed Vego is greater than a preceding vehicle moving speed Vfwd, i.e., a moving speed of the preceding vehicle 200, (ii) a moving speed difference ΔV is equal to or greater than a predetermined speed difference (or a first speed difference ΔV1), and (iii) an optimum acceleration control execution flag Xa is “1”. The moving speed difference ΔV is an absolute value of a difference between the own vehicle moving speed Vego and the preceding vehicle moving speed Vfwd, i.e., the moving speed of the preceding vehicle 200. The optimum acceleration control execution flag Xa is set to “1” when the optimum acceleration control is executed.

When the vehicle moving apparatus 10 determines “Yes” at the step S410, the vehicle moving apparatus 10 proceeds with the process to a step S415 to execute the coasting control. Then, the vehicle moving apparatus 10 proceeds with the process to step S495 to terminate executing this routine once.

On the other hand, when the vehicle moving apparatus 10 determines “No” at the step S410, the vehicle moving apparatus 10 proceeds with the process to a step S420 to determine whether (i) the own vehicle moving speed Vego is equal to or smaller than the lower limit speed Vlower, (ii) the preceding vehicle moving speed Vfwd is greater than the own vehicle moving speed Vego, (iii) the moving speed difference ΔV is equal to or smaller than a predetermined speed difference (or a second speed difference ΔV2), and (iv) a coasting control execution flag Xd is “1”. The coasting control execution flag Xd is set to “1” when the coasting control is executed.

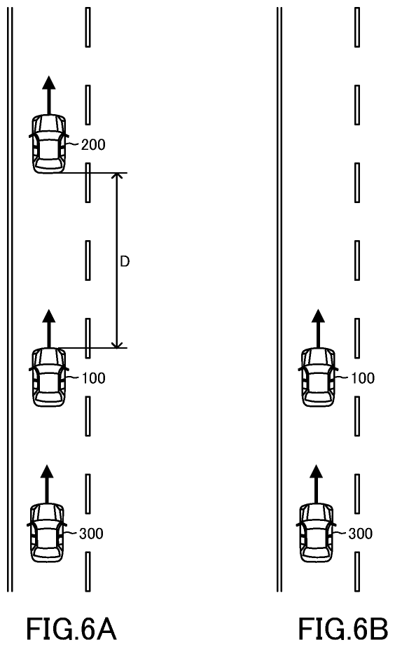

It should be noted that a condition that there is no following vehicle 300 may be added to the condition at the step S420. As shown in FIG. 6, the following vehicle 300 is another vehicle moving behind the own vehicle 100 within a predetermined distance (or a following vehicle determination distance) from the own vehicle 100. The vehicle moving apparatus 10 detects the following vehicle 300, based on the surrounding detection information IS.

When the vehicle moving apparatus 10 determines “Yes” at the step S420, the vehicle moving apparatus 10 proceeds with the process to a step S425 to determine whether a coasting time T is equal to or greater than a predetermined time (or a predetermined coasting time Tth). The coasting time T may be a time which has elapsed since the coasting control currently being executed starts to be executed, or may be a time which has elapsed since it is first determined “Yes” at the step S420 for one preceding vehicle 200. In the present embodiment, the predetermined coasting time Tth is set to a time which is greater as the own vehicle moving speed Vego is greater when the inter-vehicle distance D increases and reaches the upper limit distance Dupper while the coasting control is executed.

When the vehicle moving apparatus 10 determines “Yes” at the step S425, the vehicle moving apparatus 10 proceeds with the process to a step S430 to execute the optimum acceleration control. Then, the vehicle moving apparatus 10 proceeds with the process to the step S495 to terminate executing this routine once.

On the other hand, when the vehicle moving apparatus 10 determines “No” in the step S425, the vehicle moving apparatus 10 proceeds with the processing to a step S435 to execute the coasting control. Then, the vehicle moving apparatus 10 proceeds with the processing to the step S495 to terminate executing this routine once.

Further, when the vehicle moving apparatus 10 determines “No” at the step S420, the vehicle moving apparatus 10 proceeds with the processing to the step S435 to execute the coasting control. Then, the vehicle moving apparatus 10 proceeds with the processing to the step S495 to terminate executing this routine once.

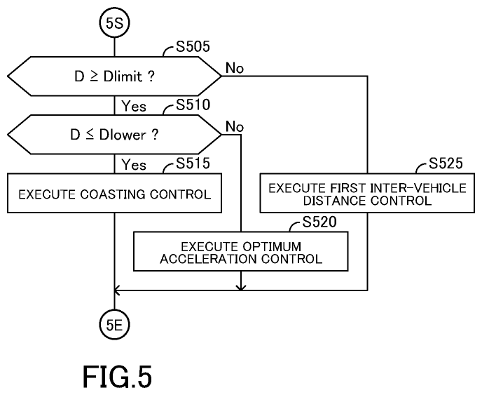

Further, when the vehicle moving apparatus 10 determines “No” at the step S405, the vehicle moving apparatus 10 proceeds with the process to a step S505 of a routine shown in FIG. 5 to determine whether the inter-vehicle distance D is equal to or greater than a predetermined distance (or a limit distance Dlimit). The limit distance Dlimit is the inter-vehicle distance D minimally required for ensuring moving safety of the own vehicle 100 and is set to be smaller than the lower limit distance Dlower.

When the vehicle moving apparatus 10 determines “Yes” at the step S505, the vehicle moving apparatus 10 proceeds with the process to a step S510 to determines whether the inter-vehicle distance D is equal to or smaller than the lower limit distance Dlower. When the vehicle moving apparatus 10 determines “Yes” at the step S510, the vehicle moving apparatus 10 proceeds with the process to a step S515 to executes the coasting control. Then, the vehicle moving apparatus 10 proceeds with the process to the step S495 of the routine shown in FIG. 4 to terminate executing this routine once.

On the other hand, when the vehicle moving apparatus 10 determines “No” at the step S510, the vehicle moving apparatus 10 proceeds with the process to a step S520 to executes the optimum acceleration control. Then, the vehicle moving apparatus 10 proceeds with the process to the step S495 of the routine shown in FIG. 4 to terminate executing this routine once.

Further, when the vehicle moving apparatus 10 determines “No” at the step S505, the vehicle moving apparatus 10 proceeds with the process to a step S525 to execute the first inter-vehicle distance control. Then, the vehicle moving apparatus 10 proceeds with the process to the step S495 of the routine shown in FIG. 4 to terminate executing this routine once.

The operations of the vehicle moving apparatus 10 have been described.

When there is the following vehicle 300 as shown in 6A while the second inter-vehicle distance control is executed, the vehicle moving apparatus 10 may be configured to set the predetermined distance range Rd such that the inter-vehicle distance D becomes an appropriate distance, based on a moving speed of the following vehicle 300 and/or a distance between the following vehicle 300 and the own vehicle 100.

Similarly, when there is the following vehicle 300 as shown in 6B while the second moving speed control is executed, the vehicle moving apparatus 10 may be configured to set the predetermined speed range Rv such that the own vehicle moving speed Vego becomes an appropriate speed, based on the moving speed of the following vehicle 300 and/or the distance between the following vehicle 300 and the own vehicle 100.

<Advantages>

When the second inter-vehicle control is executed by (i) starting to execute the coasting control when the inter-vehicle distance D reaches the upper limit distance Dupper and (ii) starting to execute the optimal acceleration control when the inter-vehicle distance D reaches the lower limit distance Dlower while the preceding vehicle 200 is frequently accelerated or decelerated, executions of the coasting control and the optimal acceleration control are frequently switched. Thereby, an amount of energy consumed for moving the own vehicle 100 increases, and the own vehicle 100 frequently approaches and leaves the preceding vehicle 200. Thereby, the driver may feel discomfort.

On the other hand, if the time of continuously executing the coasting control is increased and therefore, the time of continuously executing the optimum acceleration control is increased while the preceding vehicle 200 is frequently accelerated or decelerated, the executions of the coasting control and the optimum acceleration control are not frequently switched. Thereby, the amount of energy consumed for moving the own vehicle 100 can be reduced without giving a sense of discomfort to the driver.

With the vehicle moving apparatus 10, the coasting control continues to be executed until the predetermined coasting time Tth elapses even when the inter-vehicle distance D increases and reaches the upper limit distance Dupper when (i) the own vehicle moving speed Vego becomes equal to or smaller than the lower limit speed Vlower, (ii) the preceding vehicle moving speed Vfwd is greater than the own vehicle moving speed Vego, and (iii) the moving speed difference ΔV is equal to or greater than the first speed difference ΔV1. Therefore, the amount of energy consumed for moving the own vehicle 100 can be reduced without giving a sense of discomfort to the driver.

It should be noted that the invention is not limited to the aforementioned embodiments, and various modifications can be employed within the scope of the invention.

What is claimed is:

1. A vehicle moving apparatus, comprising an electronic control unit configured to execute an autonomous acceleration/deceleration control to autonomously control an acceleration and a deceleration of an own vehicle so as to control a distance between the own vehicle and a preceding vehicle within a predetermined distance range by (i) starting to execute a coasting control to cause the own vehicle to coast when the distance between the own vehicle and the preceding vehicle decreases and reaches a lower limit value of the predetermined distance range and (ii) starting to execute an acceleration control to accelerate the own vehicle when the distance between the own vehicle and the preceding vehicle increases and reaches an upper limit value of the predetermined distance range,
wherein the electronic control unit is configured to continue executing the coasting control until a predetermined time elapses even when the distance between the own vehicle and the preceding vehicle increases and reaches the upper limit value of the predetermined distance range when (i) a moving speed of the own vehicle becomes equal to or greater than a predetermined speed, (ii) the moving speed of the own vehicle is greater than a moving speed of the preceding vehicle, and (iii) a difference between the moving speed of the own vehicle and the moving speed of the preceding vehicle is equal to or greater than a predetermined speed difference while the coasting control is executed.

2. The vehicle moving apparatus as set forth in claim 1,
wherein the acceleration control is a control to activate an internal combustion engine of the own vehicle and accelerate the own vehicle by a power output from the internal combustion engine,
wherein the coasting control is a control to stop activating the internal combustion engine and causing the own vehicle to coast, and
wherein the predetermined time is set to a greater value as the moving speed of the own vehicle is greater when the distance between the own vehicle and the preceding vehicle increases and reaches the upper limit value of the predetermined distance range while the coasting control is executed.
